(19) United States
(12) Patent Application Publication
(10) Pub. No.: US 2024/0337520 A1
(43) Pub. Date: Oct. 10, 2024

(54) FILL LEVEL MEASURING DEVICE

(71) Applicant: Endress+Hauser SE+Co. KG, Maulburg (DE)

(72) Inventors: Pablo Ottersbach, Essen (DE); Philipp Hügler, Aalen (DE)

(21) Appl. No.: 18/579,437

(22) PCT Filed: Jul. 8, 2022
(86) PCT No.: PCT/EP2022/069032

§ 371 Date: Jan. 15, 2024

(30) Foreign Application Priority Data
Jul. 16, 2021 (DE) 10 2021 118 496.7

(51) Int. Cl. G01F 23/284; H01Q 1/22

(52) U.S. Cl. CPC G01F 23/284; H01Q 1/225

(57) ABSTRACT

A radar-based fill level measuring device comprises an antenna for transmitting and receiving the radar signals, a transmitting/receiving unit which generates the radar signal and determines the fill level on the basis of the reflected received signal, and a waveguide for transmitting the radar signals between the antenna and the transmitting/receiving unit. The fill level measuring device includes an end stop element on the waveguide and a positioning attachment on the transmitting/receiving unit. The positioning attachment forms an end stop for the waveguide such that the waveguide is coupled to the transmitting/receiving unit so as to be secure for high frequencies. This significantly reduces the risk of the fill level measuring device being incorrectly assembled when inserting the waveguide.

The invention relates to a fill-level measuring device which is easy to manufacture, and to a method for manufacturing the fill-level measuring device.

In process automation, corresponding field devices are used for capturing relevant process parameters. To capture the different process parameters, suitable measuring principles are implemented in the corresponding field devices in order to capture as process parameters, for example, a fill-level, a flow, a pressure, a temperature, a pH value, a redox potential, or a conductivity. A wide variety of such field devices is manufactured and distributed by the Endress+Hauser corporate group.

For measuring the fill-level of filling materials in containers, contactless measuring methods have become established, because they are robust and require minimum maintenance. A further advantage of contactless measuring methods consists in the ability to be able to measure the fill-level quasi-continuously. Radar-based measuring methods are therefore predominantly used in the field of continuous fill-level measurement (in the context of this patent application, “radar” refers to signals or electromagnetic waves with frequencies between 0.03 GHz and 300 GHZ). Established measuring methods in this regard are the FMCW (frequency modulated continuous wave) and the pulse transit time methods. Radar-based, fill-level measuring methods are described in greater detail in, for example, “Radar Level Measurement,” Peter Devine, 2000.

By means of the FMCW and pulse transit time method, it is possible to measure distance or fill-level at least selectively. In this case, the point at which the fill-level is measured is guided by the orientation of the transmitting/receiving antenna or by the direction of its beam lobe (due to the generally reciprocal properties of antennas, the characteristic or the beam angle of the beam lobe of the respective antenna is independent of whether it is transmitting or receiving; in the context of the present patent application, the terms, “angle” or “beam angle,” refer to the angle at which the beam lobe is at its maximum transmission intensity or reception sensitivity). The higher the radar frequency, the narrower the beam angle, for reasons of high-frequency engineering. Since a narrow beam lobe is less susceptible to interference, radar-based fill-level measuring devices are designed with a maximum frequency in the range at or above 100 GHz.

Especially for purposes of explosion protection of the fill-level measuring device, a local separation between the active transmitting/receiving unit for generating the radar signal to be emitted or for the processing of the incoming radar signal, and also the passive antenna, is often required. The transmitting/receiving unit is therefore arranged outside the container, while the antenna has to stand in the container and is therefore exposed to the process conditions within the container. In order to realize this separation, the transmitting/receiving unit is spatially separated from the antenna by a corresponding measuring device neck. In this case, the radar signals are guided by the measuring device neck from the antenna to the transmitting/receiving unit. Among other things, for explosion protection purposes, the measuring device neck optionally also comprises a process seal which closes the container opening provided for the fill-level measuring device after installation—for example, in the form of a flange.

In addition to explosion protection requirements, the measuring device neck must fulfill other protective functions: depending upon the use, high temperatures, high pressure, or hazardous gases prevail in the interior of the container. For this reason, the measuring device neck may have to feature a pressure seal, a temperature barrier, and a gas seal. Together with the installation requirements, these functions require a clear distance between the transmitting/receiving unit and the antenna, via which the measurement signals have to be guided with as little loss as possible. In fill-level measuring devices which measure at points, this distance can be bridged by a waveguide in the measuring device neck, wherein either a hollow conductor or a dielectric waveguide can be used. Irrespective of this, the higher the frequency of the radar signal, the smaller the cross-section of the waveguide should be dimensioned. Due to the corresponding filigree design of the waveguide, at a higher frequency, it becomes increasingly difficult to position the waveguide during the production of the fill-level measuring device correctly and without damage to the waveguide, in relation to the transmitting/receiving unit, so that the radar signal is coupled in with maximum possible power.

It is accordingly an object of the invention to provide a radar-based fill-level measuring device which is easy and safe to manufacture.

The invention achieves this object by means of a radar-based fill-level measuring device for determining the fill-level of a filling material in a container, which comprises the following components:
an antenna, by means of which a radar signal can be transmitted towards the filling material and, after the radar signal is reflected on the filling-material surface, can be received as a received signal,
a transmitting/receiving unit which is designed to generate the radar signal and to determine the fill-level on the basis of the received signal, and
a waveguide which is arranged between the antenna and the transmitting/receiving unit in order to transmit the radar signals in particular in a basic mode.

According to the invention, the fill-level measuring device is characterized by an end stop element on the waveguide and a positioning attachment arranged on the transmitting/receiving unit. The positioning attachment, corresponding to the end stop element in the direction of an insertion axis, forms such an end stop for the waveguide so that the waveguide is contacted with the transmitting/receiving unit in an optimal manner in terms of high-frequency engineering, i.e., with a loss of less than −6 dB and in particular less than −0.5 dB. The waveguide can be expanded with a guide element with which the positioning attachment in turn corresponds, so that the waveguide is also guided in the direction of the insertion axis during insertion. As a result, the contacting of the waveguide during the assembly of the fill-level measuring device or when the waveguide is inserted is made substantially more secure.

In the context of the invention, it is not specified how the end stop element and the guide element or the corresponding positioning attachment are structurally designed.

The end stop element of the waveguide can, for example, be designed as a web which protrudes radially from the insertion axis, wherein the positioning attachment for forming the end stop must in this case have a groove corresponding to the web. This offers additional security against rotation of the waveguide about its axis, so that, for example, the correct polarization or the correct mode can be coupled into the waveguide. From a design point of view, the positioning attachment can be designed along the insertion axis—for example, with a cylindrical interior that has a defined inner cross-section. In this case, the guide element can be designed to correspond to the cylindrical interior or its inner cross-section. In order to shield the transmitting/receiving unit externally in terms of high-frequency engineering, the interior of the positioning attachment can also be designed to be metallically conductive. It is not relevant whether the complete positioning attachment is made of a metallically-conductive material, or whether the positioning attachment is otherwise designed to be electrically insulating.

In relation to the transmitting/receiving unit, the term, “unit,” in the context of the invention is understood to mean, in principle, any electronic circuit that is suitably designed for the intended purpose. Depending upon the requirement, it can therefore be an analog circuit for generating or processing corresponding analog signals. However, the transmitting/receiving unit can also comprise a digital circuit, such as an FPGA or a storage medium, which interacts with a computer program. The program is designed to carry out the corresponding method steps or to apply the necessary computing operations. Accordingly, the transmitting/receiving unit can be designed, for example, as a component of a monolithic semiconductor chip which comprises corresponding primary radiators, such as planar antennas or high-frequency resonators, for decoupling and coupling in the radar signals. From a manufacturing point of view, the design of the fill-level measuring device according to the invention with a defined insertable waveguide is particularly advantageous if the transmitting/receiving unit generates the radar signal with a frequency of at least 80 GHz, and in particular 180 GHZ, since the cross-section of the waveguide in such a high-frequency range is, in particular in relation to its length, correspondingly small or filigreed—for example, less than 1:10.

Analogous to the fill-level measuring device according to the invention, the object underlying the invention is achieved by a method for manufacturing the fill-level measuring device according to one of the preceding embodiments. Accordingly, the method comprises at least the method step of:
inserting the waveguide into the positioning attachment in the direction of the insertion axis until the end stop element reaches the end stop of the positioning attachment, so that the waveguide, in terms of high-frequency engineering, is contacted with the transmitting/receiving unit.

The invention will be explained in more detail with reference to the following figures. In the figures:

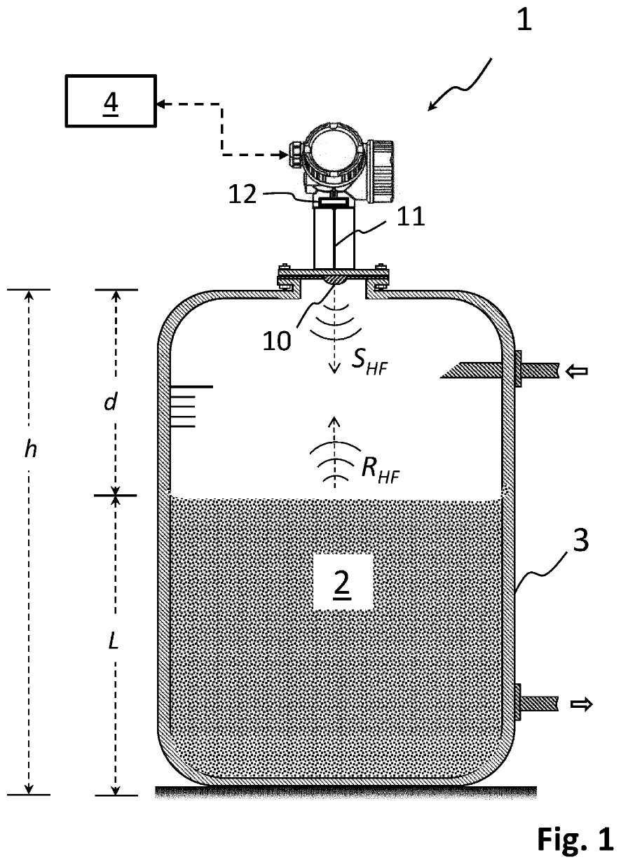

FIG. 1: shows a radar-based fill-level measuring device on a container,

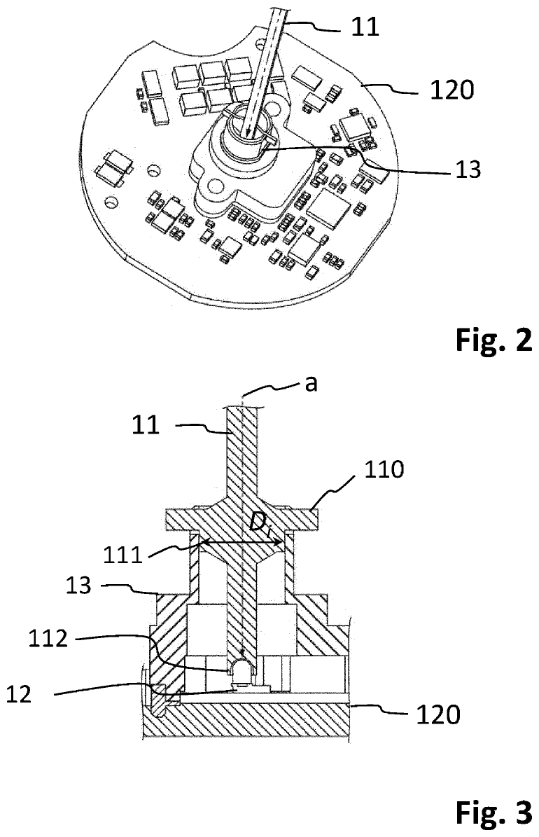

FIG. 2: shows a cutout of the fill-level measuring device in the region of the transmitting/receiving unit, and

FIG. 3: shows a positioning according to the invention of the waveguide on the transmitting/receiving unit.

To understand the fill-level measuring device 1 according to the invention, FIG. 1 shows a container 3 with filling material 2 whose fill-level L is to be detected. The container 3 can be up to more than 100 m high, depending upon the type of filling material 2 and field of application. The conditions in the tank 3 are also dependent upon the type of filling material 2 and the field of application. In the case of exothermic reactions, for example, high temperature and pressure loads can occur. In the case of dust-containing or flammable substances, appropriate explosion protection conditions must also be observed in the tank interior.

In order to be able to determine the fill-level L regardless of the prevailing conditions, a fill-level measuring device 1 is attached to a corresponding opening on the container 3 at a known installation height h above the filling material 2. In this case, the fill-level measuring device 1 is aligned and fastened such that it transmits radar signals S_{HF} via an antenna 10 in the direction of the surface of the filling material 2. Due to the sudden change in the dielectric value DK on the surface of the filling material 2, the transmitted radar signal S_{HF} is reflected on the surface of the filling material and, after a corresponding signal transit time t, is correspondingly received in the measuring device 1 as the received signal R_{HF}. In this case, the signal transit time t of the signal S_{HF}, R_{HF} according to

$$t = \frac{2 d}{c}$$

depends upon the distance d

$$d = h - L$$

from the container top to the product surface. In this case, c is the propagation speed of the radar signal S_{HF}, R_{HF} in the range of the speed of light.

To generate the radar signal S_{HF} and for processing, the fill-level measuring device 1 is designed with a corresponding transmitting/receiving unit 12; in the case of freely-radiating radar according to the pulse transit time or FMCW method, the transmitting/receiving unit 12 can, for example, comprise a frequency-regulated high-frequency oscillating circuit or an oscillating quartz. In order for the signal generation unit to generate the radar signal S_{HF} according to the respective method at the required clock rate in pulse or ramp form, the high-frequency oscillating circuit or the oscillating quartz is driven in a correspondingly clocked or modulated manner. After receiving the reflected radar signal R_{HF}, the transmitting/receiving unit 12 processes the reception signal R_{HF} via the antenna 10, depending upon the radar measurement method, by means of undersampling or by mixing with the instantaneously-emitted radar signal S_{HF} in order to be able to determine the fill-level L therefrom.

As a rule, the fill-level measuring device 1 is connected via an interface, such as PROFIBUS, HART, wireless HART, Bluetooth, or Ethernet, to a higher-level unit 4, such as a process control system or a higher-level server. In this way, the determined fill-level value L can be transmitted in order to control, if necessary, any inflows or outflows of the container 3. However, other information about the general operating state of the fill-level measuring device 1 can also be communicated.

As shown in FIG. 1, the antenna 10 is arranged in the interior of the container 3, while the transmitting/receiving unit 12 is arranged in a separate housing outside the container 3. In order to protect the transmitting/receiving unit 12 from any thermal loads from the container interior, or to separate the container interior in compliance with explosion protection from the transmitting/receiving unit 12, the housing or the transmitting/receiving unit 12 is therefore spaced apart from the antenna 10 by a measuring device neck. In this case, the measuring device neck, which defines the distance between the antenna 10 and the housing, is designed to be correspondingly long. For explosion protection-compliant sealing of the measuring device neck, a hermetic separation can also be arranged in its interior, which is based, for example, upon a glass or a ceramic and is introduced by means of welding in the measuring device neck.

According to the representation in FIG. 1, the high-frequency connection of the transmitting/receiving antenna 10 to the transmitting/receiving unit 12 takes place via a waveguide 11, which runs parallel to the axis of the device neck within the measuring device neck. In this case, the waveguide can in principle be designed both as a hollow conductor and as a dielectric waveguide. In the embodiment variant shown in FIG. 1 or FIG. 2, the waveguide 11 is designed as a dielectric waveguide and can be based, for example, upon a corresponding dielectric plastic such as PP, PFA, PTFE, or PEEK. In contrast to the embodiment variant shown in FIG. 2, the waveguide 11 can be designed not only with a rectangular cross-section, but also with a round cross-section.

FIG. 2 shows an enlarged cutout of the waveguide 11 in the region of the transmitting/receiving unit 12 which, together with any additional electronic components of the fill-level measuring device 1, is arranged on a printed circuit board substrate 120. In this case, the transmitting/receiving unit 12 can be designed as a monolithic semiconductor component in which the radar signals S_{HF}, R_{HF} are transmitted and received via a primary radiator in the direction of the insertion axis a. Such a design consumes correspondingly little space on the printed circuit board 120.

As shown, a positioning attachment 13 is arranged according to the invention on the substrate 120 next to or above the transmitting/receiving unit 12. This serves to position the corresponding end region 112 of the waveguide 11, during the assembly of the fill-level measuring device 1, taking into account the production tolerances, in such a gap-free manner with respect to the transmitting/receiving unit 12 that the waveguide 11, in terms of radar engineering, is sufficiently coupled to the transmitting/receiving unit 12, i.e., with at most a −6 dB loss.

For this purpose, the positioning attachment 13 and the waveguide 11 are designed to correspond to one another, so that the waveguide 11 can be inserted, with the end section 112 leading in the direction of the axis a, along which the radar signals S_{HF}, R_{HF} are guided in the waveguide 11, up to a defined end stop point. The end stop point is selected such that the end region 112 of the waveguide 11 is at an optimal distance from the transmitting/receiving unit 12 in terms of high-frequency coupling. In addition, when the waveguide 11 is inserted in the direction of the waveguide axis a, the positioning attachment 13 forms a guide for the waveguide 11, so that the transmitting/receiving unit 12 is located in a straight extension of the axis a of the waveguide 11 during insertion and after reaching the end stop point. This also optimizes the coupling of the radar signals S_{HF}, R_{HF} between the waveguide 11 and transmitting/receiving unit 12. In this context, the exemplary embodiment of the positioning attachment 13 shown in FIG. 2 is designed such that the waveguide or insertion axis a is aligned approximately orthogonally to the surface of the substrate 120.

The cross-sectional view of FIG. 3 in the region of the positioning attachment 13 illustrates how such a favorable high-frequency guide or such an end stop of the waveguide 11 can be achieved:

For realizing the end stop, the waveguide 11 has two webs as an end stop element 110. In this case, the webs project radially from the insertion or waveguide axis a and are aligned rotationally symmetrically, i.e., 180° opposite to one another in relation to the axis a. The positioning attachment 13 has two grooves corresponding to the webs 110. This implementation offers the advantage that the webs 110 additionally secure the waveguide 11 in the end stop against rotation. This is relevant in order to couple the radar signal S_{HF}, R_{HF} in the optimal basic mode, such as the TM01 mode, for example.

As can also be seen from FIG. 3, the positioning attachment 13 is designed along the insertion axis a with an interior which, in a region below the grooves, has a cylindrical cross-section with a defined inner diameter Dᵢ. Corresponding to the cylindrical region of the interior, the waveguide 11 has a guide element 111 with a corresponding diameter Dᵢ below the webs 110 in relation to the insertion direction. As a result, the waveguide 11 is guided along the insertion axis a or along the axis a of the waveguide 11 during insertion up to the end stop. In the exemplary embodiment shown in FIG. 3, the guide element 111 is oriented congruently with the two webs 110 in relation to the waveguide axis a, so that the waveguide 11 is less complex with respect to its shape and can accordingly be manufactured more easily. In this connection, the waveguide 11 or the integral webs 110 and the integral guide element 111 can be manufactured, for example, from PP, PFA, PTFE, or PEEK by means of injection molding.

### LIST OF REFERENCE SIGNS

1 Fill-level measuring device
2 Filling material
3 Container
4 Superordinate unit
10 Antenna
11 Waveguide
12 Transmitting/receiving unit
13 Positioning attachment
110 End stop element
111 Guide element
112 End region of the waveguide
120 Substrate
a Insertion axis
Dᵢ Inner diameter
d Distance
h Installation height
L Fill-level
R_{HF} Reflected radar signal
S_{HF} Radar signal

1-10. (canceled)

11. A radar-based, fill-level measuring device for determining a fill-level of a filling material in a container, comprising:
an antenna via which a radar signal can be transmitted towards the filling material and, after the radar signal is reflected on a filling material surface, can be received as a received signal;
a transmitting/receiving unit designed to generate the radar signal and to determine the fill-level on the basis of the received signal;
a waveguide arranged for transmitting the radar signals between the antenna and the transmitting/receiving unit wherein the waveguide includes an end stop element; and
a positioning attachment arranged on the transmitting/receiving unit which forms an end stop for the waveguide corresponding to the end stop element in a direction of an insertion axis so that the waveguide is contacted with the transmitting/receiving unit.

12. The fill-level measuring device according to claim 11, wherein the waveguide includes a guide element, and the positioning attachment is designed to correspond to the guide element so that the waveguide is guided in the direction of the insertion axis.

13. The fill-level measuring device according to claim 11, wherein the end stop element of the waveguide is designed as a web which protrudes radially from the insertion axis, and wherein the positioning attachment has a groove corresponding to the web to form the end stop.

14. The fill-level measuring device according to claim 11, wherein the waveguide is designed to transmit the radar signal or the received signal in a basic mode.

15. The fill-level measuring device according to claim 11, wherein the waveguide is designed as a dielectric waveguide which is manufactured from PP, PFA, PTFE, or PEEK.

16. The fill-level measuring device according to claim 12, wherein the positioning attachment along the insertion axis has a cylindrical interior with a defined inner cross-section, and wherein the guide element is designed corresponding with the inner cross-section.

17. The fill-level measuring device according to claim 16, wherein the interior is designed to be metallically conductive.

18. The fill-level measuring device according to claim 11, wherein the transmitting/receiving unit is designed as a monolithic semiconductor component.

19. The fill-level measuring device according to claim 11, wherein the transmitting/receiving unit is designed to generate the radar signal with a frequency of at least 80 GHz.

20. A method for manufacturing a fill-level measuring device, comprising:
inserting a waveguide into a positioning attachment in a direction of an insertion axis until an end stop element on the waveguide reaches an end stop of the positioning attachment so that the waveguide is contacted with a transmitting/receiving unit of the fill-level measuring device.
